(19) United States
(12) Patent Application Publication
(10) Pub. No.: US 2007/0191558 A1
(43) Pub. Date: Aug. 16, 2007

(54) Olefin polymerization procatalyst compositions and method of preparation

(76) Inventors: Kelly A. Gonzalez, Katy, TX (US); Tak W. Leung, Houston, TX (US)

Correspondence Address: UNION CARBIDE CHEMICALS AND PLASTICS TECHNOLOGY;CORPORATION, P.O. BOX 1967, MIDLAND, MI, 48641-1967, US

(21) Appl. No.: 10/591,042

(22) PCT Filed: Feb. 24, 2005
(86) PCT No.: PCT/US05/05842

§ 371 Date: Aug. 29, 2006

Related U.S. Application Data
(60) Provisional application No. 60/560,175, filed on Apr. 7, 2004.

(51) Int. Cl. C08F 4/44; B01J 37/00

(52) U.S. Cl. 526/124.3; 502/126; 502/127

(57) ABSTRACT

A method of making a solid procatalyst composition for use in a Ziegler-Natta olefin polymerization catalyst composition, the resulting catalyst, and a polymerization process employing the same, said method comprising: (a) contacting a solid precursor composition a magnesium compound with a halogenating agent and an internal electron donor in any order, in a suitable reaction medium under metathesis reaction conditions, and separating the solid reaction product; (b) optionally contacting the solid reaction product from step (a) with a halogenating agent in a suite reaction medium one or more additional times under metathesis reaction conditions and separating the solid reaction product; (c) contacting the solid reaction product of step (a) or optionally (b) with a halogenating agent and a liquid diluent comprising an aliphatic ether, aliphatic polyether or aliphatic (poly)glycol ether one or more times under metathesis reaction conditions in a suitable reaction medium and optionally extracting the resulting product.

### CROSS REFERENCE STATEMENT

This application claims the benefit of U.S. Provisional Application No. 60/560,175, filed Apr. 7, 2004.

### BACKGROUND OF THE INVENTION

The present invention relates to improved polymerization catalyst compositions of the Ziegler-Natta type, procatalysts for use in forming such catalyst compositions, methods of making such catalyst compositions and procatalysts, and to methods of using the catalyst compositions to make an olefin polymer.

Ziegler-Natta olefin polymerization catalyst compositions typically comprise a solid component containing magnesium, titanium and halide moieties in combination with an internal electron donor (which combination is referred to as the “procatalyst”), a substance (“cocatalyst”) that is capable of converting the procatalyst to an active polymerization catalyst, and a selectivity control agent (SCA) or external donor. Suitable internal electron donors especially include aromatic mono- or di-allylesters or ether derivatives thereof, such as alkylbenzoates, diallklphthalates, and C₁₋₄ alkyl ether derivatives thereof. Conventional cocatalysts include alkylaluminum compounds, especially trialkylaluminum compounds, such as triethylaluminum or triisobutylaluminum. The cocatalyst may be combined or complexed with some or all of the internal electron donor, selectivity control agent, or both, if desired. Although variations in any of these catalyst components will influence the performance of the resultant catalyst, the component that appears to offer the greatest opportunity for modification to produce greater catalyst activity is the procatalyst.

Various methods of preparing procatalysts are previously disclosed in the patent art. Examples include: U.S. Pat. Nos. 5,247,032, 5,247,031, 5,229,342, 5,153,158, 5,151,399, 5,146,028, 5,124,298, 5,106,806, 5,082,907, 5,077,357, 5,066,738, 5,066,737, 5,034,361, 5,028,671, 4,990,479, 4,927,797, 4,829,037, 4,816,433, 4,728,705, 4,548,915, 4,547,476, 4,540,679, 4,535,068, 4,472,521, 4,460,701, 4,442,276, and 4,330,649. One preferred method from among the foregoing disclosures is a method of forming a “procatalyst precursor” from a mixture of magnesium dialkoxides and titanium alkoxides and reacting the mixture with titanium tetrachloride or similar chlorinating agent, in the presence of an alcohol, an aromatic hydroxide compound, and an aromatic solvent, especially chlorobenzene. In this manner, a solid material is recovered by selective precipitation upon removal of alcohol from the solution. This precursor may thereafter be contacted with an internal electron donor and washed with TiCl₄ in a halohydrocarbon solvent to form the desired procatalyst. Among the foregoing disclosures, U.S. Pat. Nos. 5,124,298, 5,082,907, and 4,535,068 disclose that an acid chloride, such as benzoyl chloride or phthaloyl chloride, may be used before, together with or after the halogenation. In U.S. Pat. No. 6,395,670, an ether is employed as an electron donor in a Ziegler-Natta catalyst composition.

### SUMMARY OF THE INVENTION

According to the present invention, there is provided a method of making a solid procatalyst composition for use in a Ziegler-Natta olefin polymerization catalyst composition, said method comprising:

(a) contacting a solid precursor composition comprising a magnesium compound with a halogenating agent and an internal electron donor in any order, in a suitable reaction medium under metathesis reaction conditions, and separating the solid reaction product;

(b) optionally contacting the solid reaction product from step (a) with a halogenating agent in a suitable reaction medium one or more additional times under metathesis reaction conditions and separating the solid reaction product;

(c) contacting the solid reaction product of step (a) or optionally (b) with a halogenating agent and a liquid diluent comprising an aliphatic ether, aliphatic polyether or aliphatic (poly)glycol ether one or more times under metathesis reaction conditions in a suitable reaction medium; and

(d) recovering the solid procatalyst composition.

Also included in the present invention are the solid procatalysts resulting from the foregoing methods of preparation; olefin polymerization catalysts comprising one or more of the foregoing procatalyst compositions, a cocatalyst, and optionally a selectivity control agent; an improved olefin polymerization process comprising contacting an olefin monomer under olefin polymerization conditions in the presence of the foregoing catalyst composition; as well as polyolefin polymers formed according to the foregoing polymerization process.

The catalyst compositions of the present invention are useful in preparing α-olefin polymers having relatively high bulk density and low atactic polymer content (low xylene solubles (XS) content). Moreover, they enable the preparation of polypropylene impact copolymers, especially polypropylene that is impact modified by ethylene/propylene copolymers prepared in situ.

### DETAILED DESCRIPTION OF THE INVENTION

All reference to the Periodic Table of the Elements herein shall refer to the Periodic Table of the Elements, published and copyrighted by CRC Press, Inc., 2001. Also, any reference to a Group or Groups shall be to the Group or Groups as reflected in this Periodic Table of the Elements using the IUPAC system for numbering groups. For purposes of United States patent practice, the contents of any patent, patent application, or publication referenced herein are hereby incorporated by reference in their entirety (or the equivalent US version thereof is so incorporated by reference) especially with respect to the disclosure of synthetic techniques, definitions (to the extent not inconsistent with any definitions provided herein) and general knowledge in the art.

The term “comprising” when used herein with respect to a composition, mixture, or process is not intended to exclude the additional presence of any other compound, component or step. The term “aromatic” or “aryl” refers to a polyatomic, cyclic, conjugated ring system containing (4δ+2) π-electrons, wherein δ is an integer greater than or equal to 1. Unless stated to the contrary, implicit from the context, or customary in the art, all parts and percents are based on weight.

As mentioned above, the olefin polymerization procatalyst precursors employed in the invention comprise magnesium moieties. Sources for such magnesium moieties include anhydrous magnesium chloride, magnesium dialkoxides or aryloxides, or carboxylated magnesium dialkoxides or aryloxides. Preferred sources of magnesium moieties are magnesium di(C₁₋₄)alkoxides, especially diethoxymagnesium. Additionally, the precursors desirably comprise titanium moieties. Suitable sources of titanium moieties include titanium alkoxides, titanium aryloxides, and/or titanium halides. Preferred precursors comprise one or more magnesium di(C₁₋₄)alkoxides and one or more titanium tetra(C₁₋₄)alkoxides.

Various methods of making procatalyst precursor compounds are known in the art. These methods are described, inter alia, in U.S. Pat. Nos. 5,034,361; 5,082,907; 5,151,399; 5,229,342; 5,106,806; 5,146,028; 5,066,737; 5,077,357; 4,442,276; 4,540,679; 4,547,476; 4,460,701; 4,816,433; 4,829,037; 4,927,797; 4,990,479; 5,066,738; 5,028,671; 5,153,158; 5,247,031; 5,247,032, and elsewhere. In a preferred method, the preparation involves chlorination of the foregoing mixed magnesium and titanium alkoxides, and may involve the use of one or more compounds, referred to as “clipping agents”, that aid in forming specific compositions via a solid/solid metathesis. Examples of suitable clipping agents include trialkylborates, especially triethylborate, phenolic compounds, especially cresol, and silanes.

A preferred procatalyst precursor for use herein is a mixed magnesium/titanium compound of the formula Mg_{d}Ti(OR^{e})ₑX_{f} wherein R^{e} is an aliphatic or aromatic hydrocarbon radical having 1 to 14 carbon atoms or COR^{f} wherein R^{f} is an aliphatic or aromatic hydrocarbon radical having 1 to 14 carbon atoms; each OR^{e} group is the same or different; X is independently chlorine, bromine or iodine; d is 0.5 to 5, preferably 2-4, most preferably 3; e is 2-12, preferably 6-10, most preferably 8; and f is 1-10, preferably 1-3, most preferably 2. The precursors are ideally prepared by controlled precipitation through removal of an alcohol from the reaction mixture used in their preparation. An especially desirable reaction medium comprises a mixture of an aromatic liquid, especially a chlorinated aromatic compound, most especially chlorobenzene, an alkanol, especially ethanol, and an inorganic chlorinating agent. Suitable inorganic chlorinating agents include chlorine derivatives of silicon, aluminum and titanium, especially titanium tetrachloride or aluminum sesquichloride, most especially titanium tetrachloride. Removal of the alkanol from the solution used in the chlorination, results in precipitation of the solid precursor, having especially desirable morphology and surface area. Moreover, the resulting precursors are particularly uniform particle sized and resistant to particle crumbling as well as degradation of the resulting procatalyst.

The precursor is converted to a solid procatalyst by halogenation with a halogenating agent, especially an inorganic halide compound, preferably a titanium halide compound, in the presence of an internal electron donor. If not already incorporated into the precursor in sufficient quantity, the electron donor may be added separately before, during, or after halogenation. Any method of making, recovering and storing the solid precursor is suitable for use in the present invention.

One suitable method for converting the solid procatalyst precursor into a polymerization procatalyst is by reacting the precursor with a tetravalent titanium halide, an optional hydrocarbon or halohydrocarbon, and an electron donor (if not already present). The preferred tetravalent titanium halide is titanium tetrachloride.

The optional hydrocarbon or halohydrocarbon employed in the production of olefin polymerization procatalyst preferably contains tip to 12 carbon atoms inclusive, more preferably up to 9 carbon atoms inclusive. Exemplary hydrocarbons include pentane, octane, benzene, toluene, xylene, and alkylbenzenes. Exemplary aliphatic halohydrocarbons include methylene chloride, methylene bromide, chloroform, carbon tetrachloride, 1,2-dibromoethane, 1,1,2-trichloroethane, trichlorocyclohexane, dichlorofluoromethane and tetrachlorooctane. Exemplary aromatic halohydrocarbons include chlorobenzene, bromobenzene, dichlorobenzenes and chlorotoluenes. Of the aliphatic halohydrocarbons, compounds containing at least two chloride substituents are preferred, with carbon tetrachloride and 1,1,2-trichloroethane being most preferred. Of the aromatic halohydrocarbons, chlorobenzene is particularly preferred.

Suitable electron donors are those electron donors free from active hydrogens that are conventionally employed in the formation of titanium-based procatalysts. Particularly preferred electron donors include (poly)ethers, (poly)esters, amines, imines, nitrites, phosphines, stibines, and arsines. The more preferred electron donors, however are carboxylic acid esters or ether derivatives thereof, particularly C₁₋₄ alkyl esters of aromatic monocarboxylic or dicarboxylic acids and C₁₋₄ alkyl ether derivatives thereof. Examples of such electron donors are methylbenzoate, ethylbenzoate, isopropylbenzoate, isobutylbenzoate, ethyl p-ethoxybenzoate, ethyl-p-methoxybenzoate, isopropyl-p-ethoxybenzoate, isobutyl-p-ethoxybenzoate, diethylphthalate, dimethylnaphthalenedicarboxylate, diisopropylphthalate, diisobutylphthalate, diisopropylterephthalate, and diisobutylterephthalate. The electron donor can be a single compound or a mixture of compounds, but preferably the electron donor is a single compound. Particularly preferred internal electron donors are: ethylbenzoate, ethyl p-ethoxybenzoate, di(n-butyl)phthalate, and di(isobutyl)phthalate.

In one embodiment of the invention, the electron donor may be formed in situ, by contacting the procatalyst precursor with an organic halogenating agent, especially benzoyl chloride or phthaloyl dichloride, simultaneously with the foregoing precursor forming step or halogenation step using an inorganic halide compound. Sufficient electron donor usually is provided or prepared in situ, so that the molar ratio of electron donor to the magnesium present in the solid procatalyst at this stage of the preparation is from 0.01:1 to 3:1, preferably from 0.05:1 to 2:1.

The manner in which the procatalyst precursor, the optional hydrocarbon or halohydrocarbon, the electron donor, and the halogenating agent are contacted may be varied within wide limits. In one embodiment, the tetravalent titanium halide is added to a mixture of the electron donor and procatalyst precursor. More preferably however, the procatalyst precursor first is mixed with the tetravalent titanium halide and optional halohydrocarbon, and the electron donor is added last, after a period lasting from 1 to 30 minutes of precontact between the precursor and halogenating agent. Ideally, the contact time and temperature are controlled in order to obtain a solid product having a desired particle morphology. Preferred contacting times of the precursor with the remaining ingredients in the procatalyst composition forming process are at least 10, preferably at least 15 and more preferably at least 20 minutes, up to 1 hour, preferably up to 45 minutes, most preferably up to 35 minutes, at a temperature from at least 25, preferably at least 50, most preferably at least 60° C., to a temperature up to 125, preferably up to 120, most preferably up to 115° C. At combinations of higher temperatures or longer contacting times, particle morphology, especially particle size, size distribution and porosity of the resulting solid, procatalyst composition and the catalysts formed therefrom is adversely affected.

A preferred procatalyst for use herein is a mixed magnesium/titanium compound of the formula: Mg_{d′}Ti(OR^{e})_{e′}X_{f′}(ED)_{g′} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine; ED is an electron donor, especially an aromatic monocarboxylic acid ester or an aromatic dicarboxylic acid diester; d′ is 1 to 36, preferably 6-18, most preferably 10-14; e′ is 0-3, preferably 0.01-2, most preferably 0.01-1; f′ is 20-40, preferably 25-35, most preferably 27-29; and g′ is 0.1-3, preferably 0.5-2.5, most preferably 1-2.

The next step according to the invention involves a metathesis or exchange reaction of the solid reaction product from step (a) with a halogenating agent, preferably a chlorinating agent in order to convert residual alkoxide moieties in the solid procatalyst to chloride moieties. Titanium tetrachloride is the preferred chlorinating reagent. The reaction medium preferably is a chlorinated aromatic, most preferably chlorobenzene. A small quantity of benzoylchloride may be present as well due to the fact that the alkyl benzoate which is thereby formed as a by-product of the chlorination is an effective internal donor.

Desirably, the residual alkoxide content of the resulting solid, exchanged, procatalyst composition is 5 weight percent or less, more preferably 3 weight percent or less, most preferably 1 weight percent or less. The foregoing metathesis procedure may be repeated one more time, as desired until a suitable procatalyst composition is attained.

In the final exchange process, step (c), one or more aliphatic ether, aliphatic polyether or aliphatic (poly)glycol ether compounds (“ether additive(s)”) are present in the reaction mixture. Preferred quantities of ether additive are amounts from 0.01 to 50 mmoles, more preferably from 0.05 to 25 mmoles, and most preferably from 0.1 to 10 mmoles per mole of magnesium compound in the procatalyst. Excessive quantities of ether additive are uneconomical or detrimental to catalyst activity whereas insufficient quantities of ether additive may fail to achieve the benefits of the invention. The ether additive may replace a portion of the reaction solvent. Preferably, a chlorinated aromatic compound, especially monochlorobenzene comprises the reaction solvent. The amount of ether additive present in relation to the diluent is desirably sufficient to provide a diluent:ether additive molar ratio from 3000:1 to 1:1.

The ether additive most desirably is a mono(C₁₋₄)alkylether- or a di(C₁₋₄)alkyl ether-derivative of a poly(alkylene)glycol, preferably containing 2 or 3 alkyleneoxy units, most preferably 2 or 3 propyleneoxy units in each glycol ether. Most preferred alkylether derivatives are monomethyl- or dimethyl-ether derivatives. Examples of suitable ether additives include: di(ethyleneglycol)monomethyl ether, di(ethyleneglycol)dimethyl ether, di(propyleneglycol)monomethyl ether, di(propyleneglycol)dimethyl ether, tri(ethyleneglycol)monomethyl ether, tri(ethyleneglycol)dimethyl ether, tri(propyleneglycol)monomethyl ether, tri(propyleneglycol)dimethyl ether, di(ethyleneglycol)monopropyl ether, di(ethyleneglycol)dipropyl ether, di(propyleneglycol)monopropyl ether, di(propyleneglycol)dipropyl ether, tri(ethyleneglycol)monopropyl ether, tri(ethyleneglycol)dipropyl ether, tri(propyleneglycol)monopropyl ether, tri(propyleneglycol)dipropyl ether, di(ethyleneglycol)monobutyl ether, di(ethyleneglycol)dibutyl ether, di(propyleneglycol)monobutyl ether, di(propyleneglycol)dibutyl ether, tri(ethyleneglycol)monobutyl ether, tri(ethyleneglycol)dibutyl ether, tri(propyleneglycol)monobutyl ether, and tri(propyleneglycol)dibutyl ether. Preferred ether additives are tri(propylene glycol)monomethyl ether or di(propylene glycol)dimethyl ether.

The benefits of the invention are uniquely limited to the use of the foregoing ether additives in combination with an electron donor. Merely substituting the ether additive in the catalyst composition for the electron donor does not achieve a notable benefit. According to the invention, the preparation of polymers, especially isotactic polypropylene, having reduced xylene solubles content is possible, especially when used in combination with a procatalyst precursor containing mixtures of magnesium, titanium, alkoxide and halide moieties.

The foregoing exchange processes (steps (a) (b) and (c)) are desirably conducted at an elevated temperature from 45 to 125° C., preferably from 70 to 120° C., most preferably from 85 to 115° C., over a time period of from 10 minutes to 3 hours, preferably from 30 minutes to 90 minutes, most preferably from 40 to 80 minutes. After each of the foregoing exchanges, the solid, exchanged procatalyst composition is separated from the exchange mixture, desirably by filtration, and may be rinsed with a hydrocarbon, halohydrocarbon or halocarbon solvent, if desired. Such filtration step may occur over a time period from 10 minutes to 2 hours, preferably from 30 minutes to 100 minutes. It is generally preferred that all of the foregoing chlorination and exchange steps, including intervening filtrations or other form of recovery, and optional washings, occur without substantial cooling of the solid procatalyst composition. By substantial cooling is meant cooling by more than 25° C.

After the foregoing exchange procedure, the resulting solid, exchanged, procatalyst composition is separated from the reaction medium employed in the final process, preferably by filtering to produce a moist filter cake. The moist filter cake desirably is then rinsed or washed with a liquid diluent, preferably an aliphatic hydrocarbon to remove unreacted TiCl₄ and may be dried to remove residual liquid, if desired. Typically the solid, exchanged procatalyst composition is washed one or more times with an aliphatic hydrocarbon such as isopentane, isooctane, isohexane, hexane, pentane, octane or a mixture of such hydrocarbons. The solid, exchanged, and optionally washed, procatalyst composition then can be separated and dried or slurried in a hydrocarbon, especially a relatively viscous, aliphatic hydrocarbon such as mineral oil, for further storage or use.

The resulting solid, exchanged procatalyst composition is desirably in the form of porous particles corresponding to the formula: Mg_{d″}Ti(OR^{e})_{e″}X_{f″}(ED)_{g″}(Ether)_{h″} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine; ED is an electron donor, especially diisobutylphthalate; Ether is an aliphatic ether, aliphatic polyether or aliphatic (poly)glycol ether; d″ is 1 to 36, preferably 6 to 18, most preferably 10 to 14; e″ is 0 to 2, preferably 0 to 3, preferably 0 to 0.5; f″ is 20 to 40, preferably 25 to 35, most preferably 27 to 29; and g″ is 0.1 to 3, preferably 0.5 to 2.5, most preferably 1 to 2; h″ is 0 to 5, preferably 0.001 to 2, most preferably 0.01 to 1.

Desirably, the resulting solid, exchanged, procatalyst composition has the following particle physical properties as measured by BET, nitrogen porosimetry, and laser particle analyzer: an average surface area of at least 100 m²/g, preferably at least 250 m²/g, an average pore volume of at least 0.18 cm³/g, preferably at least 0.20 cm³/g, mean particle size from 20 to 40 μm, preferably from 24 to 30 μm, and particle size distribution having D₁₀ from 3 to 15 μm, D₅₀ from 18 to 30 μm and D₉₀ from 35 to 75 μm.

Before, in combination with, or after being exchanged according to the present invention, the procatalyst composition may be further treated according to one or more of the following procedures. The solid procatalyst composition may be halogenated with a different halogenating agent or complex than previously employed; it may be contacted (extracted) with a solvent, especially a halohydrocarbon; it may be rinsed or washed, heat treated or aged. The foregoing techniques are previously known in the art with respect to different procatalyst compositions. The foregoing additional procedures may be combined in any order or employed separately, or not at all.

In a highly preferred embodiment of the present invention, all steps of the exchange process are conducted in the presence of a titanium halide and a halohydrocarbon diluent, especially TiCl₄ and chlorobenzene. If an organic halogenating agent, such as benzoylchloride, is employed in any of the metathesis steps, it normally is used in a molar ratio range, based on magnesium from 10-0.01.

The solid procatalyst composition may be extracted, if desired, to remove non-active titanium halide species by exposure to a suitable liquid diluent, optionally at an elevated temperature, and filtering the resulting solid. As an example, the solid procatalyst, may be contacted with an halohydrocarbon at an elevated temperature, for example, a temperature of up to 150° C., for a period of time. It is particularly preferred to conduct the extraction at a temperature greater than 45° C., preferably greater than 85° C., more preferably greater than 115° C., and most preferably greater than 120° C., to a temperature up to 300° C., more preferably up to 200° C., and most preferably up to 150° C.

Best results are obtained if the solid and extractant are contacted initially at or near 25° C. and then heated to an elevated temperature. Sufficient tetravalent titanium halide may be provided to further convert any residual alkoxide moieties of the procatalyst to halide groups at the same time as the extraction. The extraction process is conducted in one or more contacting operations, each of which is conducted over a period of time ranging from a few minutes to a few hours.

Suitable extractants include aliphatic, cycloaliphatic, or aromatic hydrocarbons, halogenated derivatives thereof, and mixtures thereof. Exemplary aliphatic hydrocarbons include pentane, and octane. Exemplary cycloaliphatic hydrocarbons include cyclopentane, cyclohexane, and cyclooctane. Exemplary aromatic hydrocarbons include benzene, alkylbenzenes, and dialkylbenzenes. Exemplary halogenated derivatives of the foregoing include methylenechloride, methylenebromide, chloroform, carbon tetrachloride, 1,2-dibromoethane, 1,1,2-trichloroethane, trichlorocyclohexane, dichlorofluoromethane, tetrachlorooctane, chlorinated benzenes, bromobenzene, dichlorobenzene, and chlorinated toluenes. Particularly preferred aliphatic hydrocarbons include pentane, isopentane, octane, and isooctane. Particularly preferred aromatic hydrocarbons include benzene, toluene, and xylene. Particularly preferred halohydrocarbons include carbon tetrachloride, 1,1,2-trichloroethane, chlorinated benzenes and chlorinated toluenes. Most highly preferred extractants are aromatic hydrocarbons and halohydrocarbons, especially toluene, xylene, ethylbenzene, chlorobenzene and dichlorobenzene. Desirably the extractant selected has a boiling point above the temperature used in the extraction so as to avoid the use of high pressure equipment.

The solid, exchanged procatalyst composition serves as one component of a Ziegler-Natta catalyst composition, in combination with a cocatalyst and, optionally, a selectivity control agent. The cocatalyst component employed in the Ziegler-Natta catalyst system may be chosen from any of the known activators of olefin polymerization catalyst systems employing a titanium halide, especially organoaluminum compounds. Examples include trialkylaluminum compounds and alkylaluminum halide compounds in which each alkyl group independently has from 1 to 6 carbon atoms. The preferred organoaluminum cocatalysts are triethylaluminum, triisopropylaluminum, and triisobutylaluminum. The cocatalyst is preferably employed in a molar ratio of aluminum to titanium of the procatalyst of from 1:1 to 150:1, but more preferably in a molar ratio of from 10:1 to 100:1.

The final component of the Ziegler-Natta catalyst composition (when used to polymerize C₃ and higher α-olefins) is the selectivity control agent (SCA), or external electron donor. Typical SCAs are those conventionally employed in conjunction with titanium-based Ziegler-Natta catalysts. Illustrative of suitable selectivity control agents are those classes of electron donors employed in procatalyst production as described above, as well as organosilane or polyorganosilane compounds containing at least one silicon-oxygen-carbon linkage. Suitable silicon compounds include those of the formula, R¹ₘSiYₙXₚ, or oligomeric or polymeric derivatives thereof, wherein: R¹ is a hydrocarbon radical containing from 4 to 20 carbon atoms, Y is —OR² or —OCOR² wherein R² is a hydrocarbon radical containing from 1 to 20 carbon atoms, X is hydrogen or halogen, m is an integer having a value of from 0 to 3, n is an integer having a value of from 1 to 4, p is an integer having a value of from 0 to 1, and preferably 0, and m+n+p=4. Highly preferably, R¹ in at least one occurrence is not a primary alkyl group, and the non-primary carbon thereof is attached directly to the silicon atom. Examples of R¹ include cyclopentyl, t-butyl, isopropyl or cyclohexyl. Examples of R² include methyl, ethyl, propyl, butyl, isopropyl, phenyl, benzyl and t-butyl. Examples of X are Cl and H. Each R¹ and R² may be the same or different, and, if a polyatomic radical, substituted with any substituent which is inert under the reaction conditions employed during polymerization. Silicon compounds in which two or more silicon atoms are linked to each other by an oxygen atom, such as, siloxanes or polysiloxanes, may also be employed, provided the requisite silicon-oxygen-carbon linkage is also present.

The preferred selectivity control agents are alkyl esters of aromatic carboxylic and dicarboxylic acids, ring alkoxy- substituted derivatives thereof, especially ethyl p-methoxybenzoate or ethyl p-ethoxybenzoate (PEEB), or siloxane compounds, such as n-propyltrimethoxysilane, cyclohexylmethyldimethoxysilane, or dicyclopentyldimethoxysilane. In one embodiment of the invention the foregoing selectivity control agent may form at least a portion of the internal electron donor added during procatalyst production as well. In an alternate modification, the selectivity control agent is added only after formation of the procatalyst and may be added to a catalyst forming mixture or to an olefin polymerization mixture simultaneously or non-simultaneously with addition of the cocatalyst.

The selectivity control agent preferably is provided in a quantity of from 0.01 mole to 100 moles per mole of titanium in the procatalyst. Preferred quantities of selectivity control agent are from 0.5 mole to 50 mole per mole of titanium in the procatalyst.

The olefin polymerization catalyst is produced by any suitable procedure of contacting the exchanged, solid procatalyst, the cocatalyst and optional selectivity control agent. The method of contacting is not critical. The catalyst components or combinations thereof can be precontacted prior to polymerization to form a preactivated catalyst, or the components can be contacted simultaneously with contact with an olefin monomer. In one modification, the catalyst components simply are mixed in a suitable vessel and the preformed catalyst thereby produced is introduced into the polymerization reactor when initiation of polymerization is desired. In an alternate modification, the catalyst components are separately introduced into the polymerization reactor and the catalyst is formed in situ. In a final embodiment, the catalyst components may be introduced into one polymerization reactor and prepolymerized with one or more olefin monomers and subsequently contacted with additional olefin monomers, which may be the same or different from the olefin monomers used in the prepolymerization. The subsequent polymerization may take place in the same or in a different polymerization reactor and may include separate addition of one or more of the catalyst components during said subsequent polymerization.

The olefin polymerization catalyst may be used in slurry, liquid phase, gas phase or bulk, liquid monomer-type polymerization processes as are known in the art for polymerizing olefins, or in a combination of such processes. Polymerization preferably is conducted in a fluidized bed polymerization reactor, however, by continuously contacting an alpha-olefin having 3 to 8 carbon atoms with the three components of the catalyst system, that is, the solid procatalyst component, cocatalyst and SCAs. In accordance with the process, discrete portions of the catalyst components are continuously or semi-continuously fed to the reactor in catalytically effective amounts together with the alpha-olefin and any additional components, while the polymer product is continuously or semi-continuously removed therefrom. Fluidized bed reactors suitable for continuously polymerizing alpha-olefins have been previously described and are well known in the art. Suitable fluidized bed reactors useful for this purpose are described in U.S. Pat. Nos. 4,302,565, 4,302,566 and 4,303,771 and elsewhere.

It is preferred sometimes that such fluidized beds are operated using a recycle stream of unreacted monomer from the fluidized bed reactor. In this context, it is preferred to condense at least a portion of the recycle stream. Additionally, a liquid condensing agent may be included in the reaction mixture as well. The foregoing procedures are referred to as “condensing mode.” Operating a fluidized bed reactor in condensing mode generally is known in the art and described in, U.S. Pat. Nos. 4,543,399 and 4,588,790, and elsewhere. The use of condensing mode has been found to be especially useful to increase catalyst activity, lower the amount of xylene solubles in isotactic polypropylene, and to improve overall catalyst performance when using catalysts prepared according to the present invention.

The precise procedures and conditions of the polymerization are broadly conventional but the olefin polymerization process, by virtue of the use therein of the polymerization catalyst formed from the solid procatalysts of the invention, provides a polyolefin product and particularly a polypropylene product having a relatively high bulk density in quantities that reflect the relatively high productivity of the olefin polymerization catalyst. Desirably, the bulk density of the resulting polymer (ρ_{bd}) as determined by gravimetric analysis is at least 0.33 g/cm³, more preferably at least 0.35 g/cm³. Increase in bulk density allows higher reactor capacity utilization or efficiency of operation, and accordingly is desired.

The xylene solubles content of the polyolefin products of the invention preferably are less than 2.5 weight percent, more preferably less than 2.0 weight percent. In addition, the polyolefin product preferably will contain reduced amounts of the catalyst residue. Preferably, the polymer will have a titanium content of less than 1×10⁻³ weight percent, more preferably less than 1×10⁻⁴ weight percent, most preferably less than 5×10⁻⁵ weight percent.

The polymerization product of the present invention can be any product, including homopolymers, copolymers, and terpolymers. Usually, the polymerization product is a homopolymer such as polyethylene or polypropylene, particularly polypropylene. Alternatively, the catalyst and process of the invention are useful in the production of copolymers including copolymers of ethylene and propylene such as EPR and polypropylene impact copolymers, such as EPR modified polypropylene, when two or more olefin monomers are supplied to the polymerization process, optionally in multiple reactors, operating in series.

The following enumerated specific embodiments of the invention are provided for purposes of complete disclosure:

1. A method of making a solid procatalyst composition for use in a Ziegler-Natta olefin polymerization catalyst composition, said method comprising:

(a) contacting a solid precursor composition comprising a magnesium compound with a halogenating agent and an internal electron donor in any order, in a suitable reaction medium under metathesis reaction conditions, and separating the solid reaction product;

(b) optionally contacting the solid reaction product from step (a) with a halogenating agent in a suitable reaction medium one or more additional times under metathesis reaction conditions and separating the solid reaction product;

(c) contacting the solid reaction product of step (a) or optional step (b) with a halogenating agent and a liquid diluent comprising an aliphatic ether, aliphatic polyether or aliphatic (poly)glycol ether one or more times under metathesis reaction conditions in a suitable reaction medium; and

(d) recovering the solid procatalyst composition.

2. The method of embodiment 1 wherein the internal electron donor is a C₁₋₄ allyl ester of an aromatic monocarboxylic- or dicarboxylic acid, or a C₁₋₄ alkyl ether derivative thereof.

3. The method of embodiment 2 wherein the internal electron donor is ethylbenzoate, ethyl p-ethoxybenzoate, di(n-butyl)phthalate, or di(isobutyl)phthalate.

4. The method of embodiment 1 wherein step (c) is conducted at a temperature from 20° C. to 120° C. for a time from 10 minutes to 3 hours.

5. The method of embodiment 1 wherein step (c) is conducted at a temperature within the range of from 70° C. to 115° C. for a time from 30 to 90 minutes.

6. The method of embodiment 1 wherein in step (c) the halogenating agent comprises titanium tetrachloride and the liquid diluent comprises a mixture of monochlorobenzene and a (poly)alkylene glycol mono(C₁₋₄) alkylether or a (poly)alkylene glycol di(C₁₋₄)alkylether.

7. The method of embodiment 1 wherein in step (c) the halogenating agent comprises titanium tetrachloride and the liquid diluent comprises a mixture of monochlorobenzene and a (poly)alkylene glycol di(C₁₋₄)alkylether.

8. The method of embodiment 6 wherein the molar ratio of monochlorobenzene: (poly)alkylene glycol monoalkylether is from 3000:1 to 1:1.

9. The method of embodiment 7 wherein the molar ratio of monochlorobenzene: (poly)alkylene glycol dialkylether is from 3000:1 to 1:1.

10. The method of embodiment 6 where the (poly)alkylene glycol monoalkylether is tri(propylene glycol) monomethyl ether.

11. The method of embodiment 7 where the (poly)alkylene glycol dialkylether is di(propylene glycol)dimethyl ether.

12. A solid procatalyst composition for use in a Ziegler-Natta olefin polymerization prepared according to the method of embodiment 1.

13. A Ziegler-Natta olefin polymerization catalyst composition comprising a solid procatalyst composition according to embodiment 12, a cocatalyst, and an external selectivity control agent.

14. A process for polymerizing an olefin monomer comprising contacting the olefin monomer under polymerization conditions with a Ziegler-Natta olefin polymerization catalyst composition according to embodiment 13

15. An olefin polymer prepared by the process recited in embodiment 14.

16. A method of making a solid procatalyst composition for use in a Ziegler-Natta olefin polymerization catalyst composition, said method comprising:

(a) contacting a solid precursor composition comprising a magnesium compound with a halogenating agent and an internal electron donor in any order, in a suitable reaction medium under metathesis reaction conditions, and separating the solid reaction product;

(b) optionally contacting the solid reaction product from step (a) with a halogenating agent in a suitable reaction medium one or more times under metathesis reaction conditions and separating the solid reaction product;

(c) contacting the solid reaction product of step (a) or optional step (b) with a halogenating agent and a liquid diluent comprising an aliphatic ether, aliphatic polyether or aliphatic (poly)glycol ether one or more times under metathesis reaction conditions in a suitable reaction medium;

(d) separating the solid procatalyst from the reaction medium of step (c);

(e) extracting the solid procatalyst composition by contacting the same one or more times with a liquid diluent at an elevated temperature for a period of time sufficient to prepare a solid procatalyst composition having a decreased titanium content compared to the titanium content of the solid procatalyst composition before said extraction, and

(f) recovering the solid procatalyst composition.

17. The method of embodiment 16 wherein the diluent in step (e) is selected from the group consisting of toluene, xylene, isopentane, isooctane, chlorobenzene and dichlorobenzene.

18. The method of embodiment 17 wherein the diluent is chlorobenzene.

19. The method of embodiment 17 wherein the extraction is conducted at a temperature above 45° C.

20. The method of embodiment 17 wherein extraction takes place at a temperature between 120° C. and 150° C.

21. The method of embodiment 17 where the extraction is conducted for a period ranging from 5 minutes to 24 h.

22. The method of embodiment 17 wherein the extraction is repeated at least once.

23. A solid procatalyst composition for use in a Ziegler-Natta olefin polymerization prepared according to the method of embodiment 16.

24. A Ziegler-Natta olefin polymerization catalyst composition comprising the solid procatalyst composition of embodiment 23, a cocatalyst, and a selectivity control agent.

25. A process for polymerizing an olefin monomer comprising contacting the olefin monomer under polymerization conditions with a Ziegler-Natta olefin polymerization catalyst composition according to embodiment 24.

26. An olefin polymer prepared by the process recited in embodiment 25.

The invention is further illustrated by the following examples that should not be regarded as limiting of the present invention.

### EXAMPLES

In the following examples, the following testing methods were used to determine the values reported in the tables. In the tables, a blank cell indicates that no data were taken for that particular portion of the experiment.

Ti percent—percent titanium was determined by analyzing the catalysts using x-ray fluorescence spectroscopy.

Melt Flow was determined according to ASTM 1238, Condition 230/2.12;

Bulk Density is apparent bulk density determined according to ASTM D1895-96;

Productivity—(kg of polymer per gram of procatalyst). Calculated by weighing the total amount of polymer produced and dividing by the total amount of procatalyst injected into the reactor.

XS—xylene solubles was measured by the ¹H NMR method as described in U.S. Pat. No. 5,539,309.

Flexural Modulus—1 Percent Secant Flexural Modulus, measured on injection molded samples according to ASTM D790 techniques after 3-week aging of polymer samples.

Procatalyst (A)

A procatalyst precursor comprising magnesium, titanium, alkoxide and halide moieties is prepared by reacting magnesium diethoxide, titanium tetraethoxide, and titanium tetrachloride, in a mixture of orthocresol, ethanol and chlorobenzene at a temperature of 75° C. for 2 hours. The solid reaction product is precipitated by removing ethanol from the solution (by heating to 90° C.), washing with isopentane or isooctane, and drying. The resulting dried, solid composition comprises primarily a compound of the empirical formula: Mg₃Ti(OC₂H₅)₈Cl₂.

Approximately 3.0 grams of the precursor are added to a 75 ml flask. A 50/50 volume mixture of TiCl₄ and chlorobenzene (60 ml) is added to the flask, followed by 0.65 ml of diisobutylphthalate. The flask is heated in approximately 15 minutes to 115° C., and maintained at that temperature under constant agitation for 60 minutes. The resulting slurry is filtered while hot through a fritted disc at the bottom of the flask. The recovered solids are halogenated again by slurrying in 60 mL of a 50/50 volume mixture of TiCl₄ in chlorobenzene. The flask is heated in approximately 15 minutes to 115° C., and maintained at that temperature under constant agitation for 30 minutes. The solid is again collected by filtration while hot. The recovered solids are once again chlorinated by slurrying in 60 mL of a 50/50 volume mixture of TiCl₄ in chlorobenzene. Optionally, to this mixture is added an aliphatic ether, aliphatic polyether or aliphatic (poly)glycol ether (compound and quantity tabulated below). The mixture is heated to 115° C. in approximately 15 minutes and then maintained at that temperature with constant agitation for 30 minutes. The mixture is filtered while hot and the resulting solids cooled to 25° C., washed three times with 70 ml of isooctane, and then dried in a stream of dry nitrogen for at least two hours.

Procatalyst (B)

The reaction conditions used to prepare Procatalyst (A) are substantially repeated excepting that magnesium diethoxide is used in place of Mg₃Ti(OC₂H₅)₈Cl₂ as the procatalyst precursor and 1.05 mL diisobutylphthalate is used instead of 0.65 mL.

Procatalyst (C)

The reaction conditions used to prepare Procatalyst (A) are substantially repeated excepting that an ethanol solvate of magnesium chloride, MgCl₂.2.2 EtOH, is used instead of Mg₃Ti(OC₂H₅)₈Cl₂ as the precursor and 0.60 mL diisobutylphthalate is used instead of 0.65 mL.

Procatalyst (D)

The reaction conditions used to prepare Procatalyst (A) are substantially repeated excepting that 1.0 ml of diisobutylphthalate electron donor is employed. In addition, after the final chlorination, the mixture is filtered while hot and the resulting solids are washed once with 70 mL isooctane. The solids are then extracted by suspending in 60 mL chlorobenzene, heating in approximately 20 minutes to 130° C., and agitating for 60 minutes. The mixture is filtered while hot, washed twice with 70 ml of isooctane, and dried in a stream of dry nitrogen for at least 2 hours.

Polymerization Procedure

Liquid propylene (2.7 L) is added at 20-25° C. to a 1-gallon (3.8 L) autoclave reactor that has been dried under a stream of nitrogen at greater than 90° C. The reactor is heated to 62° C. with stirring, and hydrogen (125 mmol) and a premixed (20 minutes) solution of dicyclopentyldimethoxy silane selectivity control agent (SCA), 5.0 percent by weight triethylaluminum (TEAL) cocatalyst solution in heptane, and procatalyst as a 5 percent by weight mineral oil slurry are added. The temperature is raised to 67° C. and maintained at that temperature for 1 h. After venting and cooling of the polymerization reactor, the product is collected, dried in air, and weighed.

### Example 1

Procatalysts prepared according to Procatalyst (A) containing either 0.5 mmol tri(propylene glycol) monomethyl ether or no ether additive are used to polymerize propylene according to the above polymerization process. The resulting procatalyst compositions contain 3.4 percent titanium (3.1 percent for comparative procatalysts) and 14 percent diisobutylphthalate (17 percent for comparative procatalysts). The molar ratio of Al:Si:Ti is 100:25:1. Results are contained in Table 1.

TABLE 1

| | Tri(propylene glycol) | | | | | Flexural |
|---|---|---|---|---|---|---|
| | monomethyl ether | Productivity | Bulk Density | MF | XS | Modulus |
| Runs | (mmol) | (kg PP/g cat/h) | (g/cm³) | (dg/min) | (percent) | kpsi (MPa) |
| 1-1* | 0 | 29 | 0.395 | 10.2 | 2.3 | 266 (1834) |
| 1-2* | 0 | 28 | 0.389 | 3.7 | 2.3 | 260 (1793) |
| 1-3 | 0.5 | 32 | 0.419 | 5.2 | 1.5 | 283 (1951) |
| 1-4 | 0.5 | 29 | 0.391 | 3.0 | 1.6 | 279 (1924) |

*Comparative, not an example of the invention

### Example 2

The polymerization conditions of Example 1 are substantially repeated with varying amounts of the ether additive. Results are contained in Table 1

TABLE 2

| | mmol tri(propylene | Productivity | Bulk Density | MF | XS |
|---|---|---|---|---|---|
| Runs | glycol) monomethyl ether | (kg PP/g cat/h) | (g/cm³) | (dg/min) | (wt. percent) |
| 2-1* | 0 | 32 | 0.419 | 5.0 | 2.3 |
| 2-2 | 0.5 | 30 | 0.407 | 3.8 | 1.6 |
| 2-3 | 1.0 | 27 | 0.435 | 4.0 | 1.5 |
| 2-4 | 1.5 | 17 | 0.402 | 6.8 | 1.9 |

*Comparative, not an example of the invention

### Example 3

The reaction conditions of Example 1 are substantially repeated using 0.5 mmol of different ether compounds. Results are contained in Table 3

TABLE 3

| | | Productivity | Bulk Density | MF | XS |
|---|---|---|---|---|---|
| Runs | ether | (kg PP/g cat/h) | (g/cm³) | (dg/min) | (wt. percent) |
| 3-1 | Ethylene glycol | 33 | 0.422 | 9.0 | 2.2 |
| | dimethyl ether | | | | |
| 3-2 | Di(ethylene glycol) | 15 | 0.443 | 4.8 | 1.1 |
| | dimethyl ether | | | | |
| 3-3 | Tri(ethylene glycol) | 17 | 0.432 | 12.3 | 1.3 |
| | dimethyl ether | | | | |
| 3-4 | Tetra(ethylene glycol) | 25 | 0.407 | 8.1 | 2.2 |
| | dimethyl ether | | | | |

### Example 4

The polymerization conditions of Example 1 are substantially repeated using di(propyleneglycol) dimethylether as the ether additive and various procatalysts. Results are contained in Table 4

TABLE 4

| | | mmol | Productivity | Bulk Density | MF | XS |
|---|---|---|---|---|---|---|
| Runs | Procatalyst | glycol ether | (kg PP/g cat/h) | (g/cm³) | (dg/min) | (percent) |
| 4-1* | A | — | 24.1 | 0.422 | 9.0 | 1.8 |
| 4-2 | A | 0.5 | 21.1 | 0.426 | 4.6 | 1.3 |
| 4-3* | B | — | 25.2 | 0.355 | 5.1 | 2.0 |
| 4-4 | B | 0.5 | 18.1 | 0.351 | 4.6 | 1.3 |
| 4-5* | C | — | 11.5 | 0.334 | 13.3 | 3.5 |
| 4-6 | C | 0.5 | 21.6 | 0.428 | 7.3 | 2.2 |

*Comparative, not an example of the invention

### Example 5

The polymerization conditions of Example 1 are substantially repeated using extracted procatalyst (D) and 0.5 mmol of an ether additive. Results are contained in Table 5.

TABLE 5

| | | Productivity | Bulk Density | MF | XS |
|---|---|---|---|---|---|
| Runs | ether | (kg PP/g cat/h) | (g/cm³) | (dg/min) | (wt. percent) |
| 5-1* | — | 19.0 | 0.472 | 10.0 | 0.8 |
| 5-2 | Di(propylene glycol) | 12.1 | 0.453 | 7.9 | 0.6 |
| | dimethyl ether | | | | |
| 5-3 | Tri(propylene glycol) | 12.0 | 0.431 | 4.0 | 0.6 |
| | dimethyl ether | | | | |

*Comparative, not an example of the invention

1. A method of making a solid procatalyst composition for use in a Ziegler-Natta olefin polymerization catalyst composition, said method comprising:
(a) contacting a solid precursor composition comprising a magnesium compound with a halogenating agent and an internal electron donor in any order, in a suitable reaction medium under metathesis reaction conditions, and separating the solid reaction product;
(b) optionally contacting the solid reaction product from step (a) with a halogenating agent in a suitable reaction medium one or more additional times under metathesis reaction conditions and separating the solid reaction product;
(c) contacting the solid reaction product of step (a) or optional step (b) with a halogenating agent and a liquid diluent comprising an aliphatic ether, aliphatic polyether or aliphatic (poly)glycol ether one or more times under metathesis reaction conditions in a suitable reaction medium; and
(d) recovering the solid procatalyst composition.

2. The method of claim 1 wherein the internal electron donor is a C₁₋₄ allyl ester of an aromatic monocarboxylic- or dicarboxylic acid, or a C₁₋₄ alkyl ether derivative thereof.

3. The method of claim 2 wherein the internal electron donor is ethylbenzoate, ethyl p-ethoxybenzoate, di(n-butyl)phthalate, or di(isobutyl)phthalate.

4. The method of claim 1 wherein step (c) is conducted at a temperature from 20° C. to 120° C. for a time from 10 minutes to 3 hours.

5. The method of claim 1 wherein step (c) is conducted at a temperature within the range of from 70° C. to 115° C. for a time from 30 to 90 minutes.

6. The method of claim 1 wherein in step (c) the halogenating agent comprises titanium tetrachloride and the liquid diluent comprises a mixture of monochlorobenzene and a (poly)alkylene glycol mono(C₁₋₄) alkylether or a (poly)alkylene glycol di(C₁₋₄)alkylether.

7. The method of claim 1 wherein in step (c) the halogenating agent comprises titanium tetrachloride and the liquid diluent comprises a mixture of monochlorobenzene and a (poly)alkylene glycol di(C₁₋₄)alkylether.

8. The method of claim 6 wherein the molar ratio of monochlorobenzene: (poly)alkylene glycol monoalkylether is from 3000:1 to 1:1.

9. The method of claim 7 wherein the molar ratio of monochlorobenzene: (poly)alkylene glycol dialkylether is from 3000:1 to 1:1.

10. The method of claim 6 where the (poly)alkylene glycol monoalkylether is tri(propylene glycol)monomethyl ether.

11. The method of claim 7 where the (poly)alkylene glycol dialkylether is di(propylene glycol)dimethyl ether.

12. A solid procatalyst composition for use in a Ziegler-Natta olefin polymerization prepared according to the method of claim 1.

13. A Ziegler-Natta olefin polymerization catalyst composition comprising a solid procatalyst composition according to claim 12, a cocatalyst, and an external selectivity control agent.

14. A process for polymerizing an olefin monomer comprising contacting the olefin monomer under polymerization conditions with a Ziegler-Natta olefin polymerization catalyst composition according to claim 13

15. An olefin polymer prepared by the process recited in claim 14.

16. A method of making a solid procatalyst composition for use in a Ziegler-Natta olefin polymerization catalyst composition, said method comprising:
(a) contacting a solid precursor composition comprising a magnesium compound with a halogenating agent and an internal electron donor in any order, in a suitable reaction medium under metathesis reaction conditions, and separating the solid reaction product;
(b) optionally contacting the solid reaction product from step (a) with a halogenating agent in a suitable reaction medium one or more times under metathesis reaction conditions and separating the solid reaction product;
(c) contacting the solid reaction product of step (a) or optional step (b) with a halogenating agent and a liquid diluent comprising an aliphatic ether, aliphatic polyether or aliphatic (poly)glycol ether one or more times under metathesis reaction conditions in a suitable reaction medium;
(d) separating the solid procatalyst from the reaction medium of step (c);
(e) extracting the solid procatalyst composition by contacting the same one or more times with a liquid diluent at an elevated temperature for a period of time sufficient to prepare a solid procatalyst composition having a decreased titanium content compared to the titanium content of the solid procatalyst composition before said extraction, and
(f) recovering the solid procatalyst composition.

17. The method of claim 16 wherein the diluent in step (e) is selected from the group consisting of toluene, xylene, isopentane, isooctane, chlorobenzene and dichlorobenzene.

18. The method of claim 17 wherein the diluent is chlorobenzene.

19. The method of claim 17 wherein the extraction is conducted at a temperature above 45° C.

20. The method of claim 17 wherein extraction takes place at a temperature between 120° C. and 150° C.

21. The method of claim 17 where the extraction is conducted for a period ranging from 5 minutes to 24 h.

22. The method of claim 17 wherein the extraction is repeated at least once.

23. A solid procatalyst composition for use in a Ziegler-Natta olefin polymerization prepared according to the method of claim 16.

24. A Ziegler-Natta olefin polymerization catalyst composition comprising the solid procatalyst composition of claim 23, a cocatalyst, and a selectivity control agent.

25. A process for polymerizing an olefin monomer comprising contacting the olefin monomer under polymerization conditions with a Ziegler-Natta olefin polymerization catalyst composition according to claim 24.

26. An olefin polymer prepared by the process recited in claim 25.
